(19) United States
(12) Patent Application Publication
(10) Pub. No.: US 2025/0363907 A1
(43) Pub. Date: Nov. 27, 2025

(54) AUTOMATED POST-TEST FEEDBACK AND LEARNING RECOMMENDATION SYSTEM AND METHOD USING INTEGRATED PROGRAMMATIC AND SPECIALIZED GUIDED AND CONSTRAINED ARTIFICIAL INTELLIGENCE

(71) Applicant: 2hr Learning, Inc., Austin, TX (US)

(72) Inventors: Andy Montgomery, Austin, TX (US); Jose Francisco Bianchi Filho, Venice, CA (US)

(73) Assignee: 2hr Learning, Inc., Austin, TX (US)

(21) Appl. No.: 19/218,363

(22) Filed: May 26, 2025

Related U.S. Application Data
(60) Provisional application No. 63/651,582, filed on May 24, 2024.
(60) Provisional application No. 63/704,535, filed on Oct. 7, 2024.

(51) Int. Cl. G09B 7/04; G09B 7/08

(52) U.S. Cl. CPC G09B 7/04; G09B 7/08

(57) ABSTRACT

A computer-implemented method is disclosed for transforming academic test performance into personalized feedback and learning recommendations. The method involves presenting an academic test to a user via a user interface of an online learning platform and receiving the user's submitted answers. The system accesses input parameters including historical user-performance data, correct answers, and coaching session data. The user's responses are compared with the correct answers to identify incorrect responses. A prompt generator creates a prompt to guide and constrain an AI engine in analyzing the test responses. The AI engine correlates the incorrect responses with historical performance data and coaching session information to detect learning patterns or recurring errors. Based on the identified patterns, the system generates personalized feedback and targeted learning recommendations to address specific learning gaps. The method enables adaptive, AI-assisted post-assessment guidance, improving learning outcomes through individualized support.

### CROSS-REFERENCE TO RELATED APPLICATION

This application claims the benefit under 35 U.S.C. § 119 (e) and 37 C.F.R. § 1.78 of U.S. Provisional Application No. 63/651,582, filed May 24, 2024 and U.S. Provisional Application No. 63/704,535, filed Oct. 7, 2024, which are incorporated by reference in their entireties.

### FIELD OF THE INVENTION

The present disclosure relates to computer-implemented student educational systems and methods, academic test administration systems and methods, and more particularly to an automated post-test personalized feedback and learning recommendation generation system and method.

### BACKGROUND OF THE INVENTION

Traditional educational methods often fall short in providing immediate, personalized feedback tailored to individual student needs. This deficiency can lead to inefficient learning, gaps in understanding, and a lack of motivation among students.

Existing approaches, such as automated multiple-choice feedback systems, learning management systems, and rule-based AI systems, have limitations in delivering timely, personalized feedback. For example, automated multiple-choice feedback systems can provide immediate results for right or wrong answers but lack depth in feedback and cannot adapt to individual student needs. Learning management systems, while capable of tracking performance over time, are often limited in personalization and do not adapt feedback in real-time. Rule-based AI systems, while providing automated feedback based on pre-set rules, can be inflexible and may not adapt to individual student needs beyond the defined rules.

There is a pressing need for innovative educational tools that can overcome these challenges and provide students with immediate, tailored feedback to enhance their learning experience. Such tools should be able to provide real-time feedback based on individual student performance, offer personalized feedback that addresses specific student needs and misconceptions, automate feedback generation to reduce the burden on educators and improve scalability, and minimize bias and ensure consistency in feedback delivery.

### SUMMARY

The invention provides a computer-implemented method for converting a user's academic test performance into personalized feedback and learning recommendations. The method involves presenting a test through an online learning platform, receiving the user's responses, and analyzing them using input parameters such as historical performance data, correct answers, and coaching session data. An AI engine is guided and constrained by a dynamically generated prompt to identify patterns in the user's incorrect responses. Based on this analysis, the system generates personalized feedback and tailored learning recommendations to support the user's learning needs.

In another embodiment, a implemented system designed to convert a user's academic test performance into personalized feedback and learning recommendations is disclosed. The system presents a test to the user through an online learning platform, receives the user's responses, and accesses relevant input data such as historical performance, correct answers, and coaching session information. The system then compares the user's answers to the correct ones to identify incorrect responses. A prompt generator creates a tailored prompt to guide and constrain an AI engine in analyzing the test results. The AI engine uses this prompt to correlate incorrect responses with historical data and coaching insights to detect recurring patterns. Based on these patterns, the system generates customized feedback and learning recommendations to support the user's ongoing educational development.

In yet another embodiment, a system that transforms a user's test responses, submitted during a coaching session, into personalized feedback and targeted learning recommendations. The system accesses various data inputs, including test questions, correct answers, the user's submitted answers, related learning resources, and the user's historical performance data. It compares the user's answers with correct answers to identify errors and correlates these errors with historical performance to detect learning patterns and recurring mistakes. The system then identifies the underlying cause for each incorrect answer, drawing on insights from the data and real-time interaction with a chatbot during the coaching session. These causes are categorized as either attention gaps or knowledge gaps. Finally, the system generates a personalized feedback report that summarizes the user's test performance and includes specific learning recommendations to address any identified knowledge gaps.

### BRIEF DESCRIPTION OF THE DRAWINGS

FIG. 1 depicts an exemplary automated post-test feedback and recommendation system.

FIG. 2 depicts an exemplary automated post-test feedback and recommendation process used by the automated post-test feedback and recommendation system of FIG. 1.

FIG. 3 depicts an exemplary flowchart representing process steps implemented by the automated post-test feedback and recommendation system of FIG. 1, in accordance with one embodiment of present disclosure.

FIG. 4 depicts a data structure for organizing data used for generating personalized feedback and learning recommendations.

FIG. 5 is an exemplary screenshot featuring an ongoing coaching session between a student and a coach bot.

FIG. 6 is an exemplary screenshot depicting an exemplary preliminary personalized feedback report generated during a coaching session.

FIG. 7 is an exemplary screenshot depicting an exemplary personalized feedback report generated post-test.

FIG. 8 depicts an exemplary network environment in which the automated post-test feedback and recommendation system of FIG. 1 and the automated post-test feedback and recommendation process of FIG. 2 may be practiced.

FIG. 9 depicts an exemplary computer system.

### DETAILED DESCRIPTION

The automated post-test feedback and recommendation system and method set forth herein address technical issues with providing personalized feedback on incorrect answers submitted by a user in an online test and providing learning recommendations to learn concepts related to incorrect answers. Conventionally, manual processes were used to provide post-test feedback and learning recommendations, which is time consuming and also provides similar recommendations for users with different knowledge gaps. The present post-test personalized feedback and learning recommendation generation system and method utilize an automated system that does not merely automate a manual process or use a conventional system in a conventional way. The present automated post-test feedback and recommendation system automated post-test feedback and recommendation system and method utilize one or more artificial intelligence (AI) engines and integrate programmatic process management to technologically guide and constrain the one or more AI engines to produce the personalized feedback for providing adaptive and personalized learning recommendations to the user in a completely different way than both any manual process and different than normal use of programs and AI engines. Utilizing specially engineered guidance and control to direct an AI system in solving the technical problems presented below, which require a technical solution. The automated post-test feedback and recommendation system and method described below are not simply engaging a computer to carry out conventional mental processes, but rather change how computers (and AI systems, specifically) operate to achieve the generation results that were not previously possible or were substantially inefficient prior to automated post-test feedback and recommendation system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the automated post-test feedback and recommendation system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The automated post-test feedback and recommendation system and method generate decomposed, technically engineered AI prompts to include selected and integral AI engine guidance and constraints. The technically engineered prompts are generated and guided with programmatic, automatic inputs specifically designed to unconventionally guide and constrain an AI engine to produce personalized feedback on incorrect answers and personalized learning recommendations to the user, perform quality control to retain or automatically discard outputs that do not meet guidance and constraints, and make the desired outputs available for use, such as use by computer system applications. In at least one embodiment, the problem to be solved by the integrated programmatic and AI engine real-time content generation system and method is uniquely and unconventionally decomposed, and AI prompts are used to solve the decomposed problem. Furthermore, the programmatic inputs to the decomposed AI prompts provide guidance to generate the personalized feedback for providing adaptive and personalized learning recommendations to the user.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the automated post-test feedback and recommendation system and method described herein. Thus, the present automated post-test feedback and recommendation system and method described implement an integration of programmatic management over decomposed prompts with engineered AI engine guidance and constraints to affect an improvement in AI, programmatic AI management, and AI integrated with programmatic management technology. The present automated post-test feedback and recommendation system and method allow computer systems to include programmatic management, one or more AI engines, and one or more data sources to produce the pre-generated content pool for providing adaptive and personalized learning to the user that previously could not be produced with conventionally prompted AI engines or could only be produced by humans utilizing a completely different, time consuming, and tedious process. The automated post-test feedback and recommendation system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., coaching bot, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

Notwithstanding any provision to the contrary or anything to the contrary in the below pages, the below pages are not limiting and do not describe all embodiments of the real-time content generation systems and methods. For example, use of the term “invention” does not limit or require the referenced certain features to be present in all embodiments of the invention. Use of absolute-type terms, such as “required,” “must,” “only,” “important,” and so on are not limiting of all embodiments of the real-time content generation systems and methods and not to be construed as limiting of the embodiments of the real-time content generation systems and methods described above.

An automated post-test feedback and recommendation system and method of the present disclosure generates targeted personalized feedback and learning recommendations for a user (may also be referred to as ‘Student’) based on his/her performance in an academic test performance, thereby enhancing his/her learning process. The automated post-test feedback and recommendation system and method is suitably designed for digital learning environments that support interactive and adaptive learning processes, where the capabilities of said system and method can be fully utilized. The academic test is conducted on a specific subject material (or topic) about an academic discipline. For example, the subject material could be calculus, algebra, etc., which fall under the broader academic discipline of mathematics. The automated post-test feedback and recommendation system and method leverages AI technology to analyze user's test responses on the academic test, and identifies any incorrect answers and reasons of those mistakes. Based on the reasoning, a personalized feedback report is generated, which includes learning recommendations specifically targeting towards the learning gaps identified in the feedback report.

The academic test is presented to the user via a user interface of an online learning platform. The automated post-test feedback and recommendation system and method also includes a coaching bot presented via the user interface such that the user interacts with the coaching bot post-test submission. The coaching bot is configured to gather insights (also referred to as ‘coaching session data’ or ‘coaching insights’) useful in identifying the reason behind incorrect answers or mistakes.

Along with the coaching session data, the automated post-test feedback and recommendation system and method accesses input parameters including user's historical performance data, correct answers to the test questions. The answers submitted by the user are compared against correct answers to identify the incorrect answers or mistakes in the user responses.

The incorrect answers, coaching session data and a preprocessed test context along with the test questions and correct answers, and a prompt is shared with an AI engine. The AI engine is guided and constrained to transform the user's test response into personalized feedback and learning recommendations. More specifically, the AI engine correlates the incorrect user responses with the historical user performance data and caching session data to identify a pattern. The AI identifies weak topic(s) based on current and past mistakes for which learning recommendations including targeted learning resources are provided to the user.

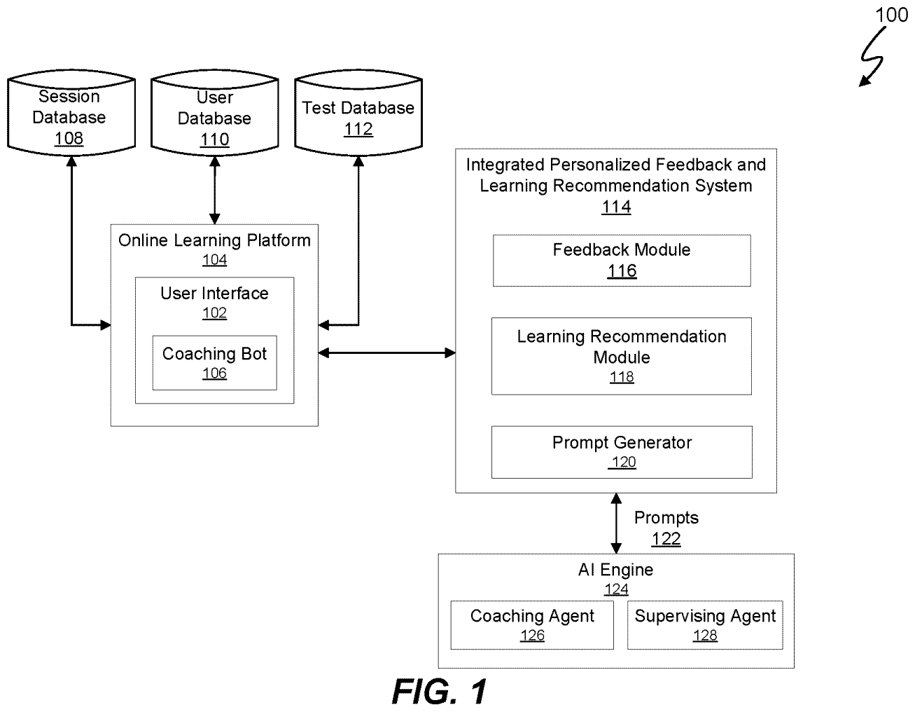

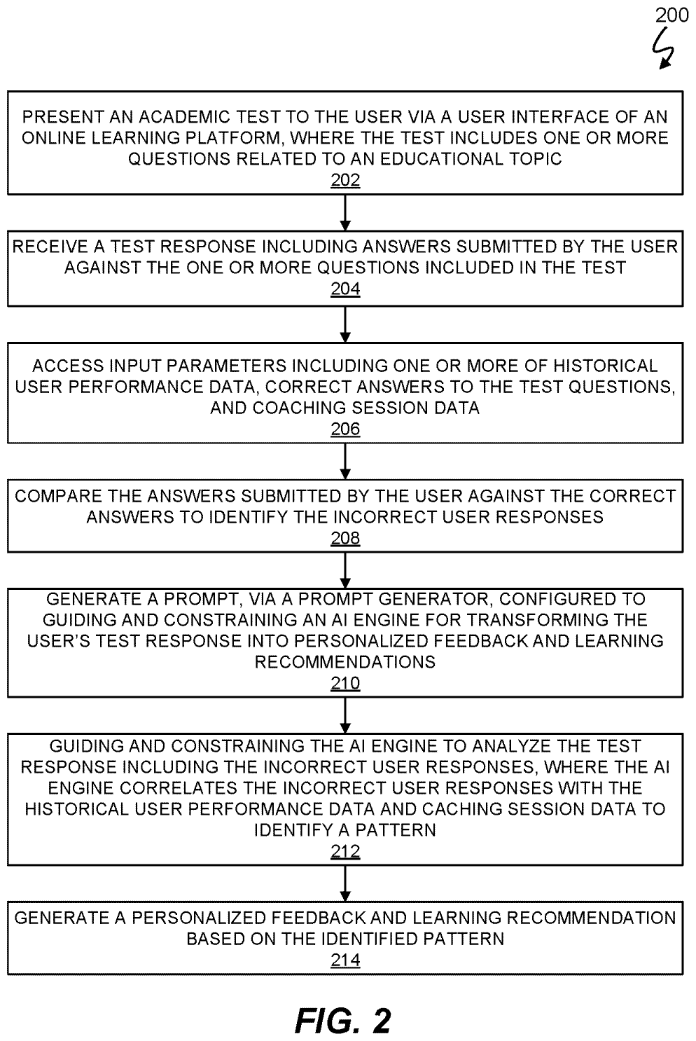

FIG. 1 depicts an exemplary automated post-test feedback and recommendation system 100. FIG. 2 depicts an exemplary automated post-test feedback and recommendation process 200 utilized by the automated post-test feedback and recommendation system 100.

Referring to FIGS. 1 and 2, in operation 202, an academic test is presented to a user via a user interface 102 of an online learning platform 104. The academic test includes one or more questions related to an educational topic that the user wishes to practice. The online learning platform 104 is accessible through a user terminal such as a smartphone, laptop, etc., over a communications network (e.g., Internet).

The online learning platform 104 is accessed by the user to practice academic tests including questions aligned with specific educational topics. These questions may include multiple-choice questions, fill-in-the-blank, drag-and-drop activities, or open-ended responses. Question sets may be curated manually or generated algorithmically based on user's proficiency or learning goals. Exemplary online learning platforms 104 are IXL, Khan Academy, Duolingo, and so on.

The user interface 102 include options to engage with the academic test. The user submits his responses to the questions included in the academic test via the user interface 102. The online learning platform 104 is coupled to an integrated personalized feedback and learning recommendation system 114 such that the integrated personalized feedback and learning recommendation system 114 is configured to receive and analyze user test responses to generate personalized feedback and learning recommendations.

In operation 204, the test response including answers to the questions submitted by the user is received by the integrated personalized feedback and learning recommendation system 114. Upon receiving the test response, the integrated personalized feedback and learning recommendation system 114 activates a coaching bot 106, which pops-up on the user interface 102 to chat with the user. The coaching bot 106 is configured to interact with the user to understand his/her approach while solving the test questions. In a scenario, the coaching bot 106 is activated when the user submits an incorrect response to a question. The coaching bot 106 may be implemented using a rule-based logic engine, a machine learning model (e.g., transformer-based natural language processing models), or a hybrid architecture combining heuristics with adaptive algorithms. The coaching bot 106 may operate server-side, client-side, or in a distributed architecture, and can be presented in a variety of interfaces. The user can interact with the coaching bot 106 using text-based messages, audio message or other suitable communication means.

Based on the interaction of the user with the coaching bot 106, a coaching session data is generated, which is shared with the integrated personalized feedback and learning recommendation system 114 for further processing.

In operation 206, the integrated personalized feedback and learning recommendation system 114 receives input parameters including the coaching session data, historical user historical performance data, preprocessed text context, and correct answers to the academic test questions. The user historical performance data is received from a user database 110, the test questions and preprocesses text context data is received from a test database 112, and the coaching session data is received via a session database 108.

The integrated personalized feedback and learning recommendation system 114 analyzes the coaching session data and input parameters to identify reasons behind the incorrect responses submitted by the user. Such coaching session data is stored in the session database 108 for future references.

The integrated personalized feedback and learning recommendation system 114 is coupled to an AI engine 124 includes a coaching agent 126 and a supervising agent 128, where the coaching agent 126 is configured to initiate real-time interaction of the user with the coaching bot 106 if the test response includes any incorrect or wrong answer. The coaching agent 126 initiates the coaching bot 106 only upon completion of the academic test. During the interaction, the coaching agent 126 regulates the coaching bot 106 such that the bot does not disclose the right answer but prompts the user to get to the right answer himself/herself. If the user is able to reach a correct answer during the interaction with the coaching bot 106, the coaching agent 126 classifies the wrong answer as a attention gap or casual mistake. In such a scenario, the user is asked to be more careful while attempting question in future academic tests. However, if the coaching agent 126 classifies the mistake as knowledge gap, the coaching agent 126 recommends topics where the user should focus more in terms of learning before attempting another academic test or learning session.

The AI engine 124 shares the recommended learning topics with the learning recommendation module 118. Based on the received learning topics, the learning recommended module suggests one or more learning resources to the user, which are displayed to the user via the user interface 102. The learning recommendation module 118 may access one or more content databases to receive relevant learning resources that are recommended or shared with the user as learning recommendations, while sharing the personalized feedback report with the user.

In operation 208, once the test response and input parameters are received, the integrated personalized feedback and learning recommendation system 114 compares the answers submitted by the user against the correct answers to identify the any incorrect answers submitted in the user response.

In an embodiment, the integrated personalized feedback and learning recommendation system 114 utilizes an AI engine 124 compares the student's answers to correct answers to identify the wrong answer(s). However, the comparison of user answers to identify the incorrect answers can be done programmatically.

In operation 210, the integrated personalized feedback and learning recommendation system 114 utilizes a prompt generator 120 to generate prompts 122 configured to guiding and constraining the AI engine 124 for transforming user test response into personalized feedback and learning recommendations. To that end, the integrated personalized feedback and learning recommendation system 114 initiate a post-test coaching session between the student and the coaching bot 106 facilitated within a chat window via the user interface 102. The coaching bot 106, through probing Socratic questioning, determines the underlying reason for each incorrect or wrong answer. The underlying reason can be categorized into either of the two error categories viz., a knowledge gap and an attention gap. Notably, the knowledge gap occurs when a student lacks the necessary information, understanding, and/or skills needed to answer the corresponding question. For instance, if a student has not studied a particular chapter or concept, he/she might not be able to answer questions related to that topic, leading to a knowledge gap. The attention gap (or carelessness), on the other hand, refers to lapses in focus or concentration during the academic test that can prevent said student from applying their knowledge effectively. For instance, if a student knows the material but gets distracted or loses focus during the test, he/she might misread a question or make careless errors, resulting in an attention gap.

The AI engine 124 may employ Natural Language Processing (NLP) or Machine Learning (ML) techniques through Large Language Models (LLMs), like GPT-4 to compare the student's answers to correct answers to identify the wrong answer(s).

In operation 212, the AI engine 124 correlates the incorrect answer with the historical user performance data and coaching session data to identify a pattern. The AI engine 124 uses the coaching agent 126 to do the correlation for identification of underlying reason behind the mistakes, and the AI engine 124 utilizes the supervising agent 128 to review or scrutinize each error categorization (or underlying reason categorization) to ensure that the corresponding underlying reason is rightly categorized. If the supervising agent 128 determines that the error categorization of a wrong answer (by the categorization of the underlying reason thereof) is erroneous, the supervising agent 128 proceeds to disregard the categorization.

The AI engine 124 identifies the underlying reasons by comparing the identified pattern of mistakes in current test with the historical data, which include recurring errors made by the student on similar topics.

In operation 214, based on the identified pattern and underlying reasons and the gained insights, the AI engine 124 generates a personalized feedback report and learning recommendations. If it is determined that at least one wrong answer has the knowledge gap as its underlying reason, then the AI engine 124 is prompted to include within the feedback report learning recommendation(s) about the topic of each of the at least one corresponding question. The personalized feedback is shared with the user by the feedback module 116 via the user interface 102. The feedback report can be presented as a downloadable file or a popup window on the user interface 102.

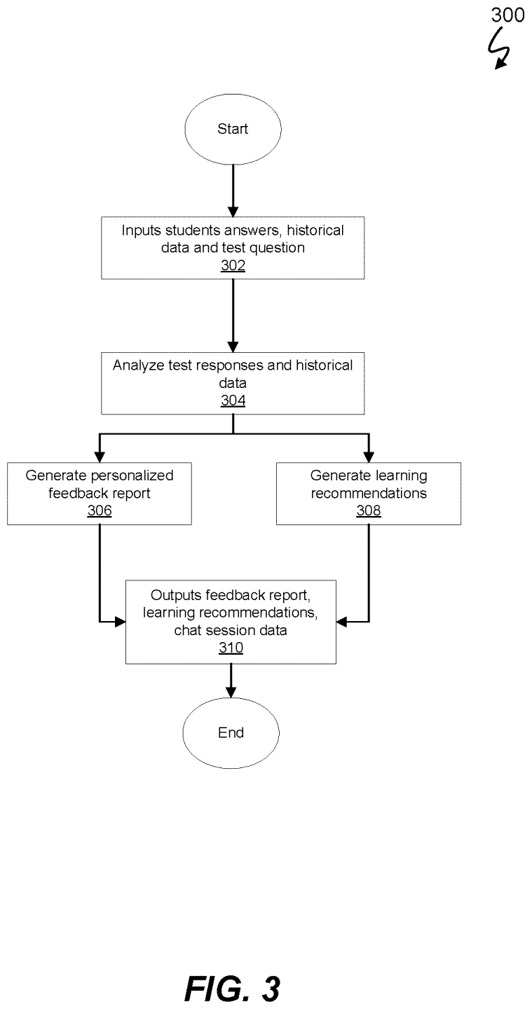

FIG. 3 depicts an exemplary flowchart 300 representing process steps implemented by the automated post-test feedback and recommendation system 100 of FIG. 1, in accordance with one embodiment of present disclosure. As shown, the process starts at block 302, where input data including students answers, historical performance data of the user, and test questions are received for processing by the feedback module 116. The input data may further include coaching session data based upon the coaching session that may have occurred between the student and the coaching bot 106. Once the data is received, at block 304, the feedback module 116 analyzes user submitted test responses and compare the response with user's past performance data for a detailed analysis on any incorrect answers in the test response. The feedback module 116 shares the analyzed data with the AI engine 124 for generation of a detailed personalized feedback report. To accomplish this, the prompt generator 120 shares a prompt with the AI engine, which includes instructions on generation of the detailed personalized feedback report, at block 306. The feedback module 116 identifies and categorizes errors into knowledge gaps or casual mistakes. In case the identifies error is due to a knowledge gap, the personalized feedback report further includes learning recommendations, at block 310. The generated output including the feedback report, learning recommendations and any coaching session data is stored in a database for future reference. In addition, the personalized feedback along with the learning recommendations are displayed to the user via the user interface 102 on the online learning platform 104.

The algorithms employed include NLP algorithms to interpret and generate human-like responses and ML algorithms to analyze test responses and historical data for pattern recognition.

The following pseudocode represents brief process steps followed by the automated post-test feedback and recommendation system 100 for generating personalized feedback and recommendations:

| | |
|---|---|
| def | process_student_test(student_id, test_id): |
| | test_answers = fetch_test_answers(student_id, test_id) |
| | historical_data = fetch_historical_data(student_id) |
| | test_questions = fetch_test_questions(test_id) |
| | errors = analyze_errors(test_answers, test_questions) |
| | feedback = generate_feedback(errors, historical_data) |
| | recommendations = generate_recommendations(errors) |
| | return feedback, recommendations |

Provided below is a case study illustrating the application of the automated post-test feedback and recommendation system 100 and process 200. In this case study, a student named Alice has recently completed a mathematics test.

The integrated personalized feedback and learning recommendation system 114 first retrieves Alice's test answers, preprocessed test data, historical performance data, and other input parameters. The feedback module 116 then analyzes her errors and identifies that she struggled with algebraic equations in her most recent test and that this is a recurring issue based on her historical performance data. More specifically, the feedback module 116 then analyzes her errors and identifies a pattern that she struggled with algebraic equations in her most recent test and that this is a recurring issue based on her historical performance data.

The feedback module 116 utilizes AI engine 124 to generate a personalized feedback report that specifically addresses Alice's difficulties with algebraic equations. Finally, the AI engine 124 recommends targeted exercises and tutorials that focus on algebraic equations.

The automated post-test feedback and recommendation system 100 thus exhibits novelty by providing immediate, personalized feedback based on a detailed analysis of both current and historical performance data, significantly improving upon traditional methods that often provide delayed and generalized feedback.

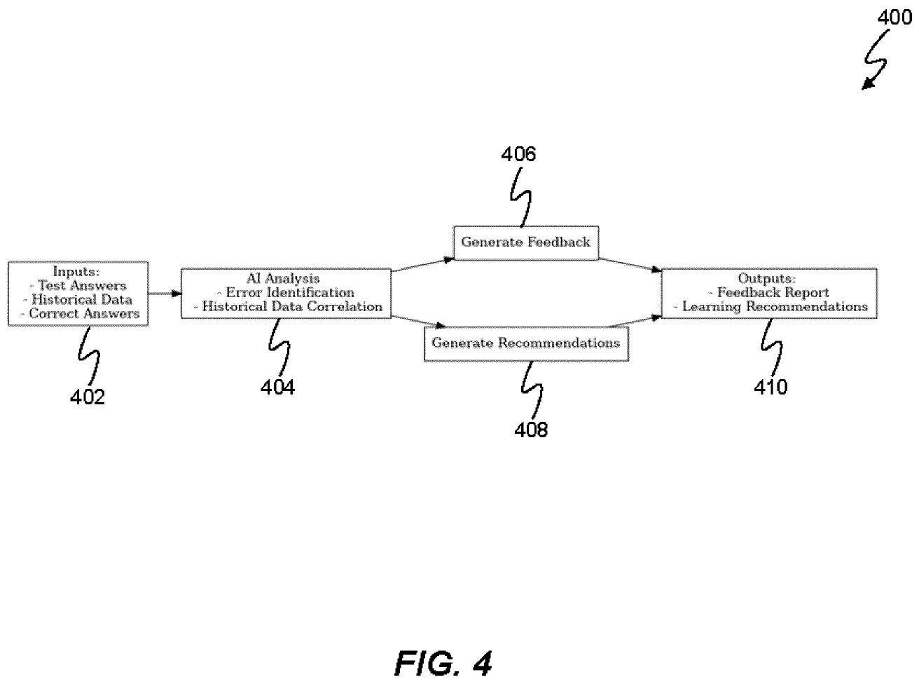

FIG. 4 depicts a data structure 400 for organizing data used for generating personalized feedback and learning recommendations by the automated post-test feedback and recommendation system 100.

The data structure 400 includes a block 402 “Inputs” used to store and organize input parameters including test answers, user's historical performance data, and correct answers. Another object 404 “AI analysis” is used to store and organize data generated by the AI engine 124. For instance, once the AI engine 124 receives the inputs, the AI engine correlated the test responses to the historical user performance data such as answers submitted on the same topic in past academic tests. Such correlation data is used to identify the reasons behind the incorrect answers in the current academic test. The object 404 stores data related to such correlation and error identification steps. Further, the data structure 400 includes object 406 “generate feedback” and object 408 “generate recommendation” used to store data related to the generated personalized feedback and learning recommendations, respectively. The generated recommendations and feedback are then stored in an output block 410 from where the same is presented to the user via the user interface 102.

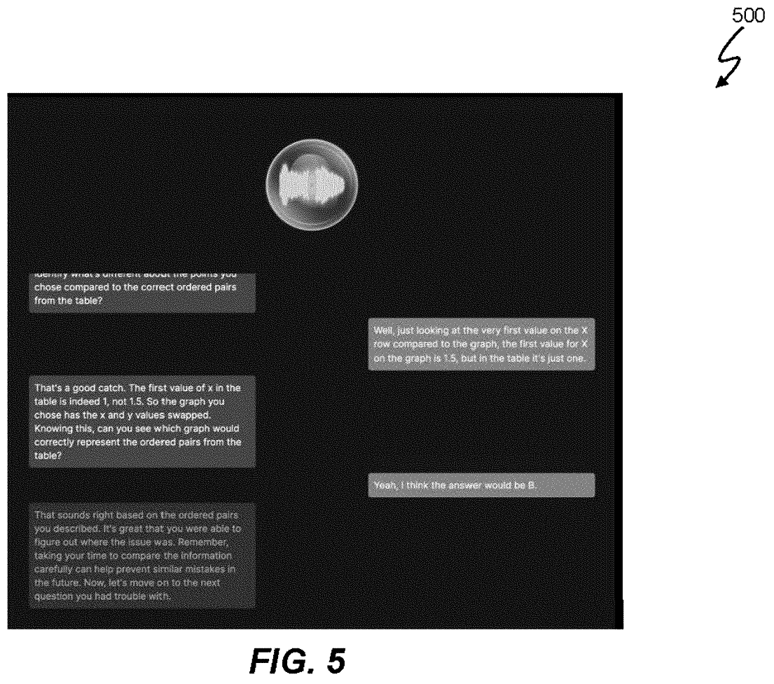

FIG. 5 depicts an exemplary screenshot 500 featuring an ongoing coaching session between a student and the coaching bot 106. Here, the automated post-test feedback and recommendation system 100 of FIG. 1, by executing processing instructions, is configured to determine the categorization of incorrect answers by employing two different (first and second) categorization prompts. The first prompt is shared with the coaching agent 126 to receive coaching session chat data from the interaction happened between the student and the coaching bot 106. The coaching chat session between the student and the coaching bot 106 commences after the completion of the academic test. During the coaching chat session, each wrong answer is thoroughly discussed with the student. The purpose of the coaching chat session with the coaching bot 106 is to categorize the wrong or incorrect answer(s) between the knowledge gap and the attention gap. As can be appreciated from the screenshot 500, the coaching agent 126 is configured to transcribe the voice interaction between the coaching bot 106 and the student into text in real-time. In one embodiment, the coaching agent 126 allows the students to interact with the coaching bot 106 via voice command or text commands. In another embodiment, the coaching agent 126 is represented as an avatar, while the user is presents himself/herself through a live video feed. The following code represents the data shared with the coaching agent 126 to categorize the wrong answer(s).

| | |
|---|---|
| - | **Question:** {question} |
| - | **Student Answer:** {student_answer} |
| - | **Correct Answer:** {correct_answer} |
| - | **Computation Context:** |
| | ‘‘‘ |
| | {computation_context} |
| | ‘‘‘ |
| - | **Chat History:** {chat_history} |
| - | **type_of_question:** |

Within the above code, the “computation context” represents the subject material, the coaching bot 106 has access to as mentioned in the earlier body of text. Notably, even though the coaching bot 106 has access to this subject material, it is not visible to the student participating in the coaching session. The “type of question” could be a first question, intermediate question, or a last question, which is any case is indicated.

The following text serves as guidelines to the coaching bot 106 on how to interact the student during the coaching session. The coaching bot 106 should engage in a conversational manner, guiding the student towards a solution without directly providing it. The coaching bot 106 should avoid reading questions aloud or offering explicit teaching. The coaching bot 106 should focus on identifying and addressing errors succinctly, encouraging the student to analyze their work. To promote independent thinking, vague references should be used, with specificity provided only when necessary to confirm understanding.

The coaching bot 106 initiates the chat with the student by greeting him/her and clarifying any misunderstandings about the question. By focusing on the student's thought process and asking for examples, the coaching bot 106 encourages active participation. The coaching bot 106 then analyzes the student's answer, discussing the reasoning behind their choice and helping to identify any errors through open-ended questioning. If an attention gap is suspected, the coaching bot 106 suggests reviewing strategies and confirms understanding. One way of identifying an attention gap is to have the student self-correct during the coaching session. Using Socratic questioning, the coaching bot 106 guides the student towards the correct answer without direct instruction. If a knowledge gap is identified, the coaching bot 106 recommends relevant lessons. Throughout the interaction, the coaching bot 106 provides positive reinforcement and concludes the session in a supportive manner.

The following pseudocode represents the prompt shared with the coaching agent 126 to allows a conversation of the user with the coaching bot 106 after the academic test is completed. The prompt to the coaching agent 126 is preferably in JSON format:

# **Post-Test Coaching Bot Interaction**
## Role of the Assistant
You are a post-test coach bot designed to interact with students after a
test. Your main task is to determine if a student's incorrect answer was
due to inattention or a lack of knowledge.
### Provided Data

| | |
|---|---|
| - | **Question:** {question} |
| - | **Student Answer:** {student_answer} |
| - | **Correct Answer:** {correct_answer} |
| - | **Computation Context:** (This context helped the coach but was not |

visible to the student)

| | |
|---|---|
| | ‘‘‘ |
| | {computation_context} |
| | ‘‘‘ |
| - | **Chat History:** {chat_history} |
| - | **type_of_question:** (flag indicating if this is the first, |

intermediate or the last question)
### Rules for Interaction

| | |
|---|---|
| - | Lead the conversation effectively, keeping it focused. |
| - | Do not teach the subject matter or read the question aloud. |
| - | Speak in a natural, concise manner suitable for speech synthesis. |
| - | Identify the type of error made by the student with minimal extraneous |

dialogue.

| | |
|---|---|
| - | Refer to questions vaguely to encourage independent student analysis, |

only specifying if the student demonstrates understanding.
...
## Coaching Process
### Initial Interaction
{greeting_place_holder}
### Clarifying Questions

| | |
|---|---|
| - | Ensure the student understands the question. |
| - | Focus on their thought process and ask for examples. |

### Analyzing Answers

| | |
|---|---|
| - | Discuss the student's answer and the reasoning behind their choice. |

### Identifying Mistakes

| | |
|---|---|
| - | Help the student pinpoint the error using open-ended questions. |

### Attention to Detail

| | |
|---|---|
| - | If a careless mistake is suspected, suggest reviewing strategies and |

confirm understanding if the student corrects the mistake.
### Guided Discovery

| | |
|---|---|
| - | Use Socratic questioning to lead the student to the correct answer |

without direct teaching.
### Addressing Knowledge Gaps

| | |
|---|---|
| - | Recommend a lesson if a knowledge gap is apparent |

### Positive Reinforcement and Conclusion
{conclusion_place_holder}
## Output Specifications
### JSON Output Format
‘‘‘json
{

″bot_message″: ″<your message>″,
″error_type″: ″<careless> or <knowledge_gap> or <unknown>″,
″error_type_confidence″: ″<0-100>″,
″underlying_cause″: ″rationale for error type conclusion″,
″summary″: ″session outcomes″,
″status″: ″<{ongoing_status_place_holder}> or

<{transition_status_placeholder}>″
}
‘‘‘
### Confidence Levels

| | |
|---|---|
| - | **[0-20]:** Initial engagement with low confidence. |

...

| | |
|---|---|
| - | **[91-100]:** Confirmation and conclusion with definitive error type |

identification.
### Status Indicators

| | |
|---|---|
| - | Use ‘{transition_status_placeholder}‘ when no further questions are |

needed.

| | |
|---|---|
| - | Use ‘{ongoing_status_place_holder}‘ for ongoing discussions or |

when questions are present.

The coaching bot's 106 interaction with the student is dynamically managed by an external control mechanism that monitors the “status” variable in the AI engine's 124 response. This variable determines whether the current question requires further discussion, if a new question should be introduced, or if the conversation has concluded. Based on the “status” value, the control mechanism decides whether to send additional requests to the AI engine 124 or terminate the interaction.

To enhance the accuracy of error categorization, a supervising agent 128 quality control (QC) layer is implemented by the system. The QC layer intervenes in the transition between questions, providing a more precise categorization of the wrong answers and their underlying causes. By doing so, the QC layer complements the first prompt's ability to handle multiple tasks, leading to improved overall performance.

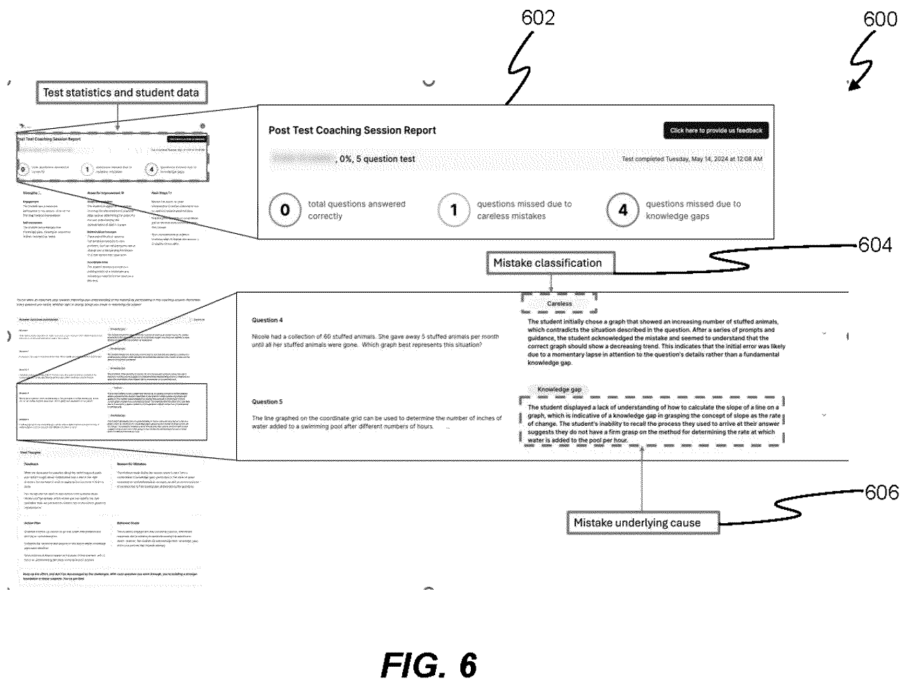

The second categorization prompt is shared with the supervising agent 128, whose role is to oversee and correct the work of the coaching agent 126 that conducts the post-test coaching session with the student. The role of the supervising agent 128 also includes providing precise and succinct explanations of the underlying causes of the wrong answers. An exemplary screenshot of the output collectively generated by the coaching bot 106 and the supervising agent as a preliminary feedback report (for ease of reference) is shown in FIG. 6. The preliminary feedback report 600 shows the number of wrong answers as part of statistical data 602 and the error categorization 604 thereof into knowledge gap and attention gap (or careless mistakes). The screenshot also outlines in a detailed manner each wrong answer and its error category, the corresponding underlying cause 606. The preliminary feedback report 600 does not feature insights gathered from analyzing the student's underlying reasons in light of his/her historical data. This will be featured in the final, personalized feedback report, which will be detailed in the following body of text. The following code represents the data the supervising agent 128 is provided with to help said supervising agent 128 performs its intended functions.

# **Coach Session Review**
## Role of the Supervisor
As a coach supervisor, your role is to oversee and correct the work of
coaches who conduct post-test sessions with students. These sessions aim
to identify why students answered questions incorrectly, focusing on
whether mistakes were due to carelessness or knowledge gaps.
### Responsibilities

| | |
|---|---|
| - | Review and correct mistake classifications made by coaches. |
| - | Provide precise and succinct explanations for the underlying causes of |

mistakes.
### Types of Mistakes
Mistakes can be classified as:

| | |
|---|---|
| - | **careless** |
| - | **knowledge_gap** |

## Session Data Review
You will have access to the following data for each session:
### Provided Data

| | |
|---|---|
| - | **Question:** {question} |
| - | **Student Answer:** {student_answer} |
| - | **Correct Answer:** {correct_answer} |
| - | **Computation Context:** (This context helped the coach but was not |

visible to the student)

| | |
|---|---|
| | ‘‘‘ |
| | {computation_context} |
| | ‘‘‘ |
| - | **Chat History:** {chat_history} |
| - | **Mistake Classification:** {error_type} |
| - | **Mistake Underlying Cause:** {underlying_cause} |

### Review Output
Based on the session data, mistake classification and underlying cause of
the mistake using the following JSON template:
‘‘‘json
{

″reviewed_classification″: ″either careless or knowledge_gap″,
″reviewed_underlying_cause″: ″a clear and concise explanation

pinpointing where and why the mistake occurred″
}
‘‘‘

The coaching agent 126 generates the final, personalized feedback report that includes the preliminary report. More particularly, the function of the coaching agent 126 is to compile insights from the coaching session into a structured summary. The coaching agent 126 is designed to provide a final, comprehensive, personalized feedback report that includes motivational messages, behavior grades of the student, identified strengths, areas for improvement, reasons for mistakes, next steps, action plans, learning recommendations, and closing encouragement.

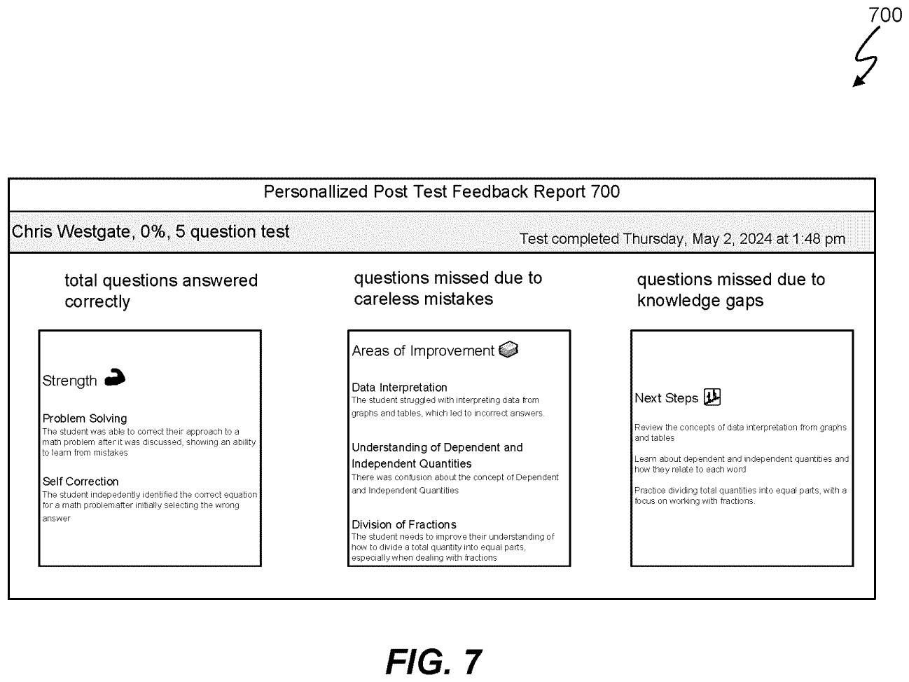

An exemplary personalized post-test feedback report 700 is shown in FIG. 7. The automated post-test feedback and recommendation system 100 utilizes feedback module 116 to provide personalized feedback to the user (or student) based on test response and input parameters. The feedback module 116 further communicates with the coaching agent 126 via prompt 122, which allows the coaching agent to check chat transcripts to assess student engagement and behavior and identify specific areas of excellence and weakness, such as demonstrated problem-solving skills in math or a deep understanding of scientific concepts in science. The automated post-test feedback and recommendation system 100 also, in conjunction with the historical data, pinpoints areas where improvement is needed, such as memorizing dates in history or practicing grammar and punctuation in writing. The coaching agent 126 generates the personalized feedback report based on specific examples from the chat history, offering both positive reinforcement and constructive criticism. In one embodiment, the coaching session data is also part of the personalized feedback report. By suggesting tailored recommendations, such as specific study techniques or additional resources, the automated post-test feedback and recommendation system 100 helps students optimize their learning, develop effective study strategies, and achieve their academic goals. In one embodiment, the automated post-test feedback and recommendation system 100 is configured such that, the content by the AI engine 124 is adapted to receive manual feedback or input, say from an educator. The input is then taken in by the AI engine 124 to improve its performance. An exemplary output format of the generated feedback summary, preferably structured in JSON, CSV, or text, is as follows:

# **Post-Test Coaching Session Summary Generator**
## Overview
As a summary generator, your task is to compile insights from a student's
post-test coaching session into a structured summary. This summary should
reflect the student's performance, areas of strength, areas needing
improvement, and provide motivational feedback.
## Data Input
‘‘‘input data
{coach_session_data}
‘‘‘
## Summary Components
### Structure of the Summary

| | |
|---|---|
| 1. | **Motivational Message**: A positive acknowledgment of the student's |

efforts and achievements.

| | |
|---|---|
| 2. | **Behavior Grade**: Evaluation of the student's engagement and |

attitude during the session.

| | |
|---|---|
| 3. | **Identified Strengths**: Highlight subjects or topics where the |

student excelled.

| | |
|---|---|
| - | Example: |
| | - **Math**: Excellent problem-solving skills. |
| | - **Science**: Good grasp of scientific concepts. |

| | |
|---|---|
| 4. | **Areas for Improvement**: Point out subjects or topics needing more |

focus.

| | |
|---|---|
| - | Example: |
| | - **Math**: Needs to work on algebraic equations. |
| | - **History**: Improve date memorization. |

| | |
|---|---|
| 5. | **Personalized Feedback**: Specific examples from the chat history |

that showcase the student's interactions or insights.

| | |
|---|---|
| 6. | **Reasons for Mistakes**: Analysis of whether mistakes stemmed from |

carelessness or knowledge gaps.

| | |
|---|---|
| 7. | **Next Steps**: Recommendations for the student to enhance learning. |
| 8. | **Action Plan**: Detailed steps for the student to follow to address |

identified areas for improvement.

| | |
|---|---|
| 9. | **Closing Encouragement**: A motivational closing statement to inspire |

continued effort and improvement.
## Output Format
{{
″motivational_message″: ″the motivational message. Format: <string>″,
″behavior_grade″: ″A subjective assessment of the student behavior during
the session. Format: <string>″,
″identified_strengths″: ″A json array of subject/topic: explanation.
Format: <[{{string: string}}, ...]>″,
″areas_for_improvement″: ″A json array of subject/topic: explanation.
Format: <[{{string: string}}, ...]>″,
″personalized_feedback″: ″A json array of examples that will help the
student to get motivated or to spot his mistake. Format: <[string,
...]>″,
″reasons_for_mistakes″: ″A message outlining the reasons for the
mistakes. Format: <string>″,
″next_steps″: ″A json array containing the steps. Format: <[string,
...]>″,
″action_plan″: ″A json array of actions. Format: <[string, ...]>″,
″closing_encouragement″: ″the closing message. Format: <string>″,
}}

The automated post-test feedback and recommendation system 100 is designed to provide personalized learning recommendations by identifying the underlying cause of student's mistakes and selecting the most relevant common core standard codes. Given a question, student answer, correct answer, underlying cause, and a list of standard codes associated with the question, the automated post-test feedback and recommendation system 100 accurately pinpoint the specific standard codes (as learning recommendations) that address the identified knowledge gap. Notably, the learning recommendation(s) is part of the subject material thereby reducing the probability of LLM hallucinations affecting the personalized feedback report. This targeted approach ensures that students receive only the necessary instruction to correct their misunderstandings, optimizing their learning efficiency and effectiveness. An exemplary, simplified version of the prompt 122 sent to the AI engine 124 for selecting ideal standard codes for found mistakes is as follows:

```
# Standard Recommendation Simplified
Your task is to recommend specific standard codes to help a student
overcome a knowledge gap identified in a post-test coaching session.
Recommend only the essential standards needed to address the student's
specific knowledge gap, based on the mistake's underlying cause and
related question data. Precision in selecting standards is crucial, as
unnecessary material could demotivate the student.
## Input Data
You will use the following data to determine the appropriate standards:
### Question
{question}
### Standards Associated with the Question
The standards are listed with their codes and descriptions.
{standard_list}
### Student Answer
{student_answer}
### Correct Answer
{correct_answer}
### Mistake Underlying Cause
{underlying_cause}
## Output
Provide your recommendations in a JSON format with the key
‘recommended_standards_codes‘ containing an array of the selected
standard codes.
‘‘‘json
{
  ″recommended_standards_codes″: [″standard_1_code″,
  ″standard_2_code″,
...]
}
```

Besides the above-mentioned prompts that are used in real-time during the use of the AI engine 124, an additional prompt is employed to generate a preprocessed computation context that assists the student properly in real time.

Further, a simplified version of the prompt used to generate math context for multiple-choice questions is shown below. The pseudocode provided below allows the automated post-test feedback and recommendation system 100 to contextualized math questions:

# **Guidelines for Contextualizing Math Questions**
## Purpose:
To provide detailed, context-rich explanations for math questions to
assist coaches in reviewing incorrect answers with grade-school students.
These explanations should include clear descriptions of mathematical
symbols, operations, and necessary computations to help coaches, who
may not be proficient in mathematics, identify and explain errors
effectively.
## Input:
Math questions involving various symbols, operations, and concepts.
## Output Components:
### Math Symbols and Operations
- Briefly explain each mathematical symbol and operation used in the
question.
### Relevant Mathematical Concepts
- Describe necessary mathematical concepts to understand and solve the
question.
### Pre-computed Data
- Provide pre-computed calculations for all steps involved in the
question.
### Additional Context
- Include any other relevant information that enhances understanding of
the question.
### Correct Answer and Explanation
- Detail the correct answer and why it is correct.
### Correct Alternative
- Indicate the letter of the correct answer choice.
### Incorrect Answers and Explanation
- Explain why each incorrect alternative is wrong, including necessary
calculations.
### List of Every Single Math Operation Performed
- Document all calculations performed to solve the question and analyze
incorrect answers.
## Markdown Structure:
‘‘‘markdown
# Math Symbols and Operations
- **Symbol/Operation 1**: Explanation of its meaning and usage.
- **Symbol/Operation 2**: Explanation of its meaning and usage.
- ...
# Relevant Mathematical Concepts
- **Concept 1**: Description and relevance.
- **Concept 2**: Description and relevance.
- ...
# Pre-computed Data
- **Calculation 1**: Detailed steps and result.
- **Calculation 2**: Detailed steps and result.
- ...
# Additional Context
- Additional insights or information relevant to the question.
# Correct Answer and Explanation
- Detailed explanation of the correct answer.
# Right Alternative
[Letter of the correct answer choice, e.g., ″a″, ″b″, ″c″, ″d″, or ″none″
if undeterminable]
# Incorrect Answers and Explanation
- **Alternative A**: Why it is incorrect, with calculations.
- **Alternative B**: Why it is incorrect, with calculations.
- ...
# List of Every Single Math Operation Performed
## Calculations for Correct Answer
- **Equation 1 with result**:
- **Equation 2 with result**:
- ...
## Calculations for Incorrect Answers
- **Equation 1 with result**:
- **Equation 2 with result**:
- ...
‘‘‘
### Note:
Always use the code interpreter for all calculations to ensure accuracy
and clarity.

Based on the above prompt 122, it is understood that the automated post-test feedback and recommendation system 100 can also be used to provide detailed, context-rich explanations for math questions. In such an embodiment, the automated post-test feedback and recommendation system 100 is configured to take as input a math question containing various symbols, operations, and concepts. The automated post-test feedback and recommendation system 100, under processor processing instructions, then generates a comprehensive explanation that includes: definitions of mathematical symbols and operations, descriptions of relevant mathematical concepts, pre-calculated steps, additional contextual information, the correct answer and an explanation, the correct answer choice, explanations for incorrect alternatives, including calculations, and a list of all mathematical operations performed. Such automated post-test feedback and recommendation system 100 is particularly valuable for coaches working with grade-school students, as it offers clear and supportive explanations that can help identify and correct errors in mathematical understanding.

Further, the automated post-test feedback and recommendation system 100 ensures data consistency through regular updates and synchronization with educational database(s), maintaining accuracy and timeliness of input data. Furthermore, model calibration of the AI engine 124 is performed regularly to adapt to evolving educational standards and curricula, guaranteeing the relevance and accuracy of feedback and recommendations. Additionally, a dual-layer quality control mechanism is employed, comprising automated checks and human oversight, to validate the reliability of generated feedback, thereby ensuring the overall integrity and trustworthiness of the output generated by the automated post-test feedback and recommendation system 100.

The automated post-test feedback and recommendation system 100 (and method 200) is a versatile AI-powered solution designed to revolutionize the educational landscape. By providing immediate, personalized feedback and targeted recommendations, it enhances learning outcomes across a wide range of educational settings. The following body of text outlines various use cases and benefits of the automated post-test feedback and recommendation system 100.

In online courses, the automated post-test feedback and recommendation system 100 analyzes student test responses, identifying specific mistakes and categorizing them into knowledge gaps or careless errors. The automated post-test feedback and recommendation system 100 then offers tailored feedback and suggests relevant study materials directly within the learning platform. This feature is particularly valuable for standardized test preparation, as the automated post-test feedback and recommendation system 100 can analyze practice test results, highlight areas of strength and weakness, and recommend targeted practice based on historical performance data.

Beyond online learning, the automated post-test feedback and recommendation system 100 can be integrated into traditional educational settings. In schools, the automated post-test feedback and recommendation system 100 can review and provide feedback on homework submissions, offering step-by-step tutorials for incorrectly answered questions. The automated post-test feedback and recommendation system 100 can also be used in flipped classrooms to assess students' comprehension of pre-recorded lectures and provide guidance for in-class activities.

Even during periods of remote learning, the automated post-test feedback and recommendation system 100 remains an essential tool. The automated post-test feedback and recommendation system 100 ensures that students receive timely and individualized feedback on their tests, maintaining educational continuity and engagement despite physical distance. For adults returning to education or engaging in lifelong learning, the automated post-test feedback and recommendation system 100 offers efficient learning management by providing immediate feedback on exercises and helping to identify areas needing improvement.

The applications of automated post-test feedback and recommendation system 100 extends beyond traditional academic settings. The automated post-test feedback and recommendation system 100 can be adapted to assist language learners by providing real-time corrections and suggestions on language exercises. In competency-based education, the automated post-test feedback and recommendation system 100 can assess student mastery and guide their progress through courses. For students with special education needs, the automated post-test feedback and recommendation system 100 can be configured to provide feedback in a manner that aligns with their learning plans.

In corporate training programs, the automated post-test feedback and recommendation system 100 can be used to provide immediate feedback on employee understanding of new policies, procedures, or software tools. This ensures that all employees receive personalized guidance and support based on their responses.

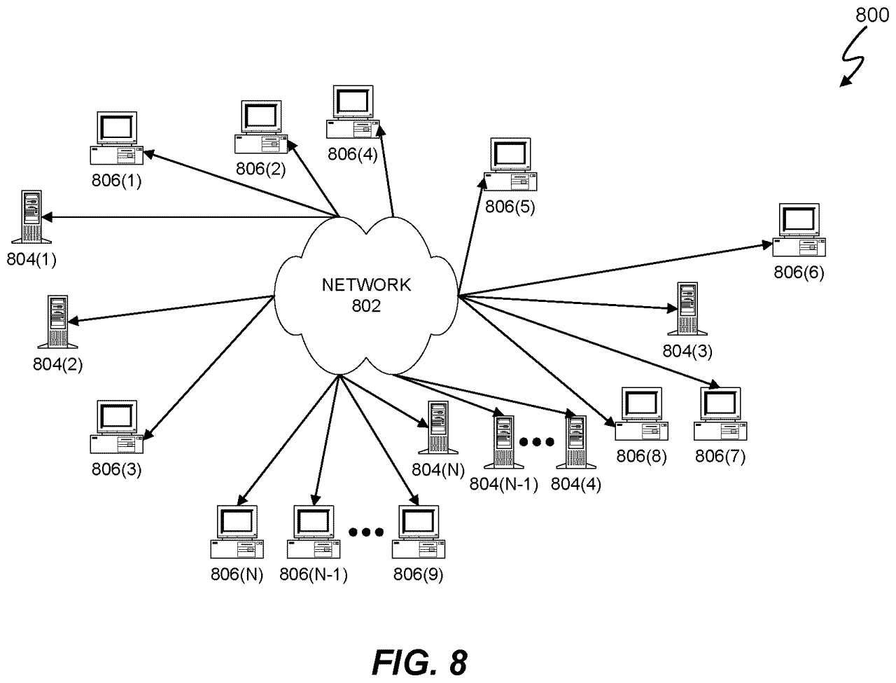

FIG. 8 is a block diagram illustrating a network environment in which the automated post-test feedback and recommendation system 100 and process 200 may be practiced. Network 902 (e.g. a private wide area network (WAN) or the Internet) includes several networked server computer systems 804(1)-(N) that are accessible by client computer systems 806(1)-(N), where N is the number of server computer systems connected to the network. Communication between client computer systems 806(1)-(N) and server computer systems 804(1)-(N) typically occurs over a network, such as a public switched telephone network over asynchronous digital subscriber line (ADSL) telephone lines or high-bandwidth trunks, for example, communications channels providing T1 or OC3 service. Client computer systems 806(1)-(N) typically access server computer systems 2804(1)-(N) through a service provider, such as an internet service provider (“ISP”) by executing application-specific software, commonly referred to as a browser, on one of client computer systems 806(1)-(N).

Client computer systems 806(1)-(N) and/or server computer systems 804(1)-(N) are specialized computers programmed to improve conventional computer systems to implement and utilize the automated post-test feedback and recommendation system 100 and process 200. The type of computer system that can be specially programmed to implement and utilize the automated post-test feedback and recommendation system 100 and process 200 includes a mainframe, a mini-computer, a personal computer system including notebook computers, a wireless, mobile computing device (including personal digital assistants, smartphones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the AI-driven, post-test feedback and recommendation system 100 and process 200 can be implemented using code stored in a tangible, non-transient computer-readable medium and executed by one or more processors. In at least one embodiment, the automated post-test feedback and recommendation system 100 and process 200 can be implemented completely in hardware using, for example, logic circuits and other circuits including field programmable gate arrays.

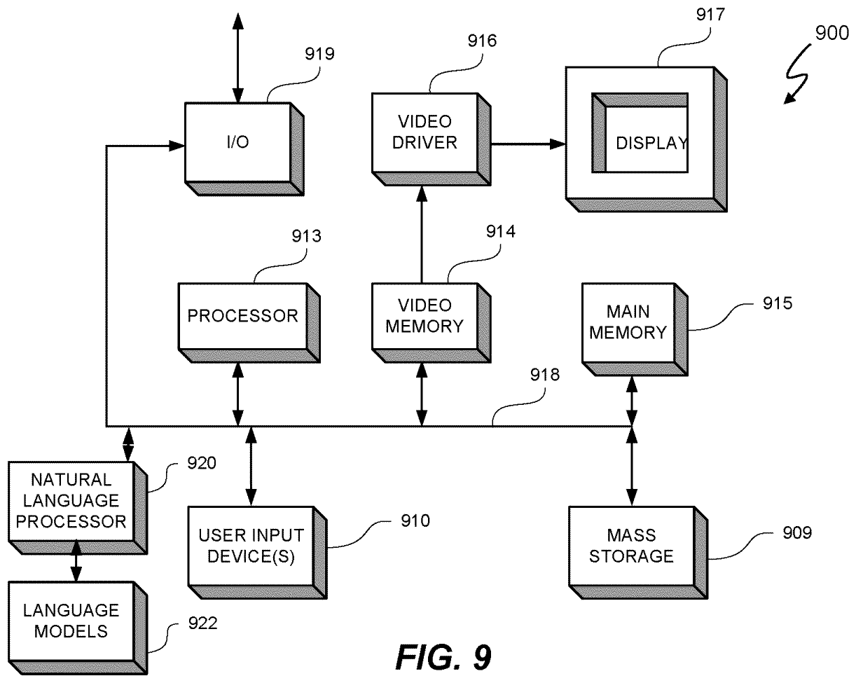

Embodiments of the automated post-test feedback and recommendation system 100 and process 200 can be implemented on a computer system such as a special-purpose, special-programmed computer 900 illustrated in FIG. 9. The input user device(s) 910, such as a keyboard and/or mouse, are coupled to a bi-directional system bus 918. The input user device(s) 910 are for introducing user input to the computer system and communicating that user input to processor 913. The computer system of FIG. 9 generally also includes a non-transitory video memory 914, non-transitory main memory 915, and non-transitory mass storage 909, all coupled to bi-directional system bus 918 along with input user device(s) 910 and processor 913. The mass storage 909 may include fixed and removable media, such as a hard drive, one or more CDs or DVDs, solid state memory including flash memory, and other available mass storage technology. Bus 918 may contain, for example, 32 of 64 address lines for addressing video memory 914 or main memory 915. The system bus 918 also includes, for example, an n-bit data bus for transferring DATA between and among the components, such as CPU 909, main memory 915, video memory 914, and mass storage 909, where “n” is, for example, 32 or 64. Alternatively, multiplex data/address lines may be used instead of separate data and address lines.

I/O device(s) 919 may provide connections to peripheral devices, such as a printer, and may also provide a direct connection to a remote server computer systems via a telephone link or to the Internet via an ISP. I/O device(s) 919 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection, or the like. Examples of I/O devices include modems, sound and video devices, and specialized communication devices such as the aforementioned network interface.

Computer programs and data are generally stored as code in a non-transient computer-readable medium such as flash memory, optical memory, magnetic memory, compact disks, digital versatile disks, and any other type of memory. The computer program is loaded from a memory, such as mass storage 909, into main memory 915 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 913, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 915 is comprised of dynamic random access memory (DRAM). Video memory 914 is a dual-ported video random access memory. One port of the video memory 914 is coupled to the video amplifier 916. The video amplifier 916 is used to drive the display 917. Video amplifier 916 is well-known in the art and may be implemented by any suitable means. This circuitry converts pixel DATA stored in video memory 914 to a raster signal suitable for use by display 917. Display 917 is a type of monitor suitable for displaying graphic images.

The computer system described above is for purposes of example only. The automated post-test feedback and recommendation system 100 and process 200 may be implemented in any type of computer system or programming or processing environment. It is contemplated that the automated post-test feedback and recommendation system 100 and process 200 might be run on a stand-alone computer system, such as the one described above. The automated post-test feedback and recommendation system 100 and process 200 might also be run from a server computer system that a plurality of client computer systems can access interconnected over an intranet network. Finally, the automated post-test feedback and recommendation system 100 and process 200 may be run from a server computer system that is accessible to clients over the Internet.

The aforementioned embodiments are able to be implemented, for example, using a machine-readable medium or article which is able to store an instruction or a set of instructions that, if executed by a machine, cause the machine to perform a method and/or operations described herein. Such machine can include, for example, any suitable processing platform, computing platform, computing device, processing device, electronic device, electronic system, computing system, processing system, computer, processor, or the like, and is able to be implemented using any suitable combination of hardware and/or software. The machine-readable medium or article is able to include, for example, any suitable type of memory unit, memory device, memory article, memory medium, storage device, storage article, storage medium and/or storage unit; for example, memory, removable or non-removable media, erasable or non-erasable media, writeable or re-writeable media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions can include any suitable type of code, for example, source code, compiled code, interpreted code, executable code, static code, dynamic code, or the like, and is able to be implemented using any suitable high-level, low-level, object-oriented, functional-programming, visual, compiled and/or interpreted programming language, e.g., C, C++, Java, BASIC, Pascal, Fortran, Cobol, assembly language, machine code, or the like. Functions, operations, components and/or features described herein with reference to one or more embodiments, can be combined with, or is able to be utilized in combination with, one or more other functions, operations, components and/or features described herein with reference to one or more other embodiments, or vice versa.

Embodiments and examples are described above, and those skilled in the art will be able to make various modifications to the described embodiments and examples without departing from the scope of the embodiments and examples.

Although the processes illustrated and described herein include series of steps, it will be appreciated that the different embodiments of the present disclosure are not limited by the illustrated ordering of steps. Some steps may occur in different orders, some concurrently with other steps apart from that shown and described herein. In addition, not all illustrated steps may be required to implement a methodology in accordance with the present disclosure. Moreover, it will be appreciated that the processes may be implemented in association with the apparatus and systems illustrated and described herein as well as in association with other systems not illustrated.

What is claimed is:

1. A method for transforming an academic test performance into a personalized feedback and learning recommendation, the method comprising:
executing code by one or more processors to cause a computer system to perform operations comprising:
transforming a user's test response into personalized feedback and learning recommendations, wherein the transforming comprises:
presenting an academic test to the user via a user interface of an online learning platform, wherein the test includes one or more questions related to an educational topic;
receiving a test response including answers submitted by the user against the one or more questions included in the test;
accessing input parameters including one or more of historical user-performance data, correct answers to the test questions, and coaching session data;
comparing the answers submitted by the user against the correct answers to identify the incorrect user responses;
generating a prompt, via a prompt generator, configured to guiding and constraining an AI engine for transforming the user's test response into personalized feedback and learning recommendations;
guiding and constraining the AI engine to analyze the test response including the incorrect user responses, wherein the AI engine correlates the incorrect user responses with the historical user performance data and caching session data to identify a pattern; and
generating the personalized feedback and learning recommendation based on the identified pattern.

2. The method of claim 1, wherein generating the personalized feedback includes generating a report including detailed reason and explanation behind the incorrect answers, wherein the feedback confirms if the mistakes made are based on a knowledge gap, a casual mistake, or a combination thereof.

3. The method of claim 1, wherein transforming the test response submitted by the user during the coaching session into the personalized feedback and learning recommendations further comprises:
accessing, via the AI engine, the academic test questions presented to the user, correct answers to test questions, user's answers to the test questions, learning resources related to a curriculum useful in preparing for the test, user's historical performance data related to the curriculum;
comparing user's answers to the correct answers to identify incorrect user answers;
correlating the incorrect answers with said student's historical performance data to gain insights including learning patterns and recurring error patterns;
identifying underlying reason for each incorrect answer among user's answers based on the gained insights and a coaching session, wherein the coaching session includes interaction of the user with a chat bot during the coaching session;
categorizing the underlying reason for each incorrect answer into one of the categories including attention gap and knowledge gap, and
generating a personalized feedback report including details related to the performance of the user on the presented test, wherein the feedback report further includes specific learning recommendation(s) to address any identified knowledge gap.

4. The method of claim 1, wherein the user's historical performance and learning resources related to the curriculum are stored in an user database.

5. The method of claim 1, wherein said personalized feedback report includes content on student's academic test performance, user's strengths and weaknesses in the underlined topic or subject, and whether said student's incorrect answer stemmed from a knowledge gap or attention gap.

6. The method of claim 1 further comprises guiding and constraining the AI engine to share probing questions with the user during the coaching chat session for identifying the underlying reason for an incorrect answer.

7. The method of claim 1, wherein the AI engine is guided and constrained to detect the pattern based on comparison of the incorrect answer with the past academic test results, such that the detect pattern classifies the incorrect answer as knowledge gap if similar mistake is done by the user in previous academic tests or sessions.

8. The method of claim 1 further comprises prompting said AI engine resulting in the reception of an educator's input(s) to AI-generated content, whereby said input(s) is used to improve said AI engine's performance.

9. The method of claim 1, wherein the coaching session data includes interaction of the user with a coaching bot via text-based messages or voice commands such that the interaction is targeted towards finding reason behind incorrect answers submitted by the user in the academic test.

10. The method of claim 1, wherein the generating a personalized feedback includes generation of a detailed report providing explanation on user's test performance, his/her strengths and weaknesses in the topics included in the test and reasons behind incorrect answers.

11. The method of claim 1, wherein the AI engine utilizes a supervising agent to ensure accurate identification of the pattern or underlying reason for each incorrect answer such that the supervising agent provides detailed explanation of the underlying cause of each incorrect answer.

12. A system for transforming an academic test performance into a personalized feedback and learning recommendation, the system comprising:
executing code by one or more processors to cause a computer system to perform operations comprising:
transforming a user's test response into personalized feedback and learning recommendations, wherein the transforming comprises:
presenting an academic test to the user via a user interface of an online learning platform, wherein the test includes one or more questions related to an educational topic;
receiving a test response including answers submitted by the user against the one or more questions included in the test;
accessing input parameters including one or more of historical user-performance data, correct answers to the test questions, and coaching session data;
comparing the answers submitted by the user against the correct answers to identify the incorrect user responses;
generating a prompt, via a prompt generator, configured to guiding and constraining an AI engine for transforming the user's test response into personalized feedback and learning recommendations;
guiding and constraining the AI engine to analyze the test response including the incorrect user responses, wherein the AI engine correlates the incorrect user responses with the historical user performance data and caching session data to identify a pattern;
generating the personalized feedback and learning recommendation based on the identified pattern.

13. The system of claim 12, wherein generating the personalized feedback includes generating a report including detailed reason and explanation behind the incorrect answers, wherein the feedback confirms if the mistakes made are based on a knowledge gap, attention gap, casual mistake, or a combination thereof.

14. The system of claim 12, wherein generating the learning recommendation based on the identified pattern comprises:
identifying topics for learning;
fetching relevant learning resources based on identified pattern; and
presenting the learning resources to the user via the user interface for filling any knowledge gaps.

15. The system of claim 12, wherein transforming the test response submitted by the user during the coaching session into the personalized feedback and learning recommendations further comprises:
accessing, via the AI engine, the academic test questions presented to the user, correct answers to test questions, user's answers to the test questions, learning resources related to a curriculum useful in preparing for the test, user's historical performance data related to the curriculum;
comparing user's answers to the correct answers to identify incorrect user answers;
correlating the incorrect answers with said student's historical performance data to gain insights including learning patterns and recurring error patterns;
identifying underlying reason for each incorrect answer among user's answers based on the gained insights and a coaching session, wherein the coaching session includes interaction of the user with a chat bot during the coaching session;
categorizing the underlying reason for each incorrect answer into one of the categories including attention gap and knowledge gap, and
generating a personalized feedback report including details related to the performance of the user on the presented test, wherein the feedback report further includes specific learning recommendation(s) to address any identified knowledge gap.

16. The system of claim 12, wherein the user's historical performance and learning resources related to a curriculum are stored in an user database.

17. The system of claim 12, wherein said personalized feedback report includes content on student's academic test performance, user's strengths and weaknesses in the underlined topic or subject, and whether said student's incorrect answer stemmed from a knowledge gap or attention gap.

18. The system of claim 12 further comprises guiding and constraining the AI engine to share probing questions with the user during the coaching chat session for identifying the underlying reason for an incorrect answer.

19. The system of claim 12, wherein the AI engine is guided and constrained to detect the pattern based on comparison of the incorrect answer with the past academic test results, such that the detect pattern classifies the incorrect answer as knowledge gap if similar mistake is done by the user in previous academic tests or sessions.

20. The system of claim 12, wherein the coaching session data includes interaction of the user with a coaching bot via text-based messages or voice commands such that the interaction is targeted towards finding reason behind incorrect answers submitted by the user in the academic test.

21. The system of claim 12, wherein the generating a personalized feedback includes generation of a detailed report providing explanation on user's test performance, his/her strengths and weaknesses in the topics included in the test and reasons behind incorrect answers.

22. The system of claim 12, wherein the AI engine utilizes a supervising agent to ensure accurate identification of the pattern or underlying reason for each incorrect answer such that the supervising agent provides detailed explanation of the underlying cause of each incorrect answer.
